(19) United States
(12) Patent Application Publication
(10) Pub. No.: US 2004/0186261 A1
(43) Pub. Date: Sep. 23, 2004

(54) Rheological adjuncts, method for production and use thereof

(76) Inventors: Heinz-Peter Rink, Munster (DE); Werner-Alfons Jung, Ascheberg (DE); Uwe Meisenburg, Duisberg (DE); Hubert Baumgart, Munster (DE); Ulrike Rockrath, Senden (DE)

Correspondence Address: BASF CORPORATION, ANNE GERRY SABOURIN, 26701 TELEGRAPH ROAD, SOUTHFIELD, MI, 48034-2442, US

(21) Appl. No.: 10/482,981

(22) PCT Filed: Aug. 6, 2002
(86) PCT No.: PCT/EP02/08755

(30) Foreign Application Priority Data
Aug. 9, 2001 (DE) 101 39 262.1

(51) Int. Cl. C08G 18/00

(52) U.S. Cl. 528/44

(57) ABSTRACT

A rheological aid comprising at least one urea derivative preparable by reacting

(A) at least one compound containing at least one isocyanate group with

(B) at least one coreactant selected from the group consisting of sterically hindered primary and secondary monoamines;

and its use to prepare pseudoplastic coating materials, adhesives, and sealing compounds.

The present invention relates to a novel rheological aid. The present invention further relates to a novel process for preparing rheological aids. The present invention additionally relates to the use of the novel rheological aid for preparing coating materials, adhesives, and sealing compounds.

Rheological aids for establishing pseudoplasticity (cf. Römpp Lexikon Lacke und Druckfarben, Georg Thieme Verlag, Stuttgart, N.Y., 1998, “pseudoplasticity”, page 546) and pseudoplastic coating materials comprising them have been known for a long time. The use of rheological aids in coating materials is intended among other things to make it possible to apply comparatively thick paint films without the occurrence of disruptive runs.

The known rheological aids comprise urea derivatives, which can be prepared preferably by reacting polyisocyanates with monoamines or monoisocyanates with polyamines. Suitable rheological aids and urea derivatives are known, for example, from the references EP 0 192 304 A1, DE 18 05 693 A1, WO 94/22968, DE 27 51 761 C2, WO 97/12945 and farbe+lack, 11/1992, pages 829 ff., WO 00/31194, WO 00/37520, DE 199 24 172 A1, DE 199 24 171 A1 and DE 199 24 170 A1. In general, it is preferred to use methoxypropylamine, benzylamine and/or n-hexylamine. No sterically hindered monoamines are used.

The German patent DE 23 59 923 discloses the preparation of rheological aids from polyisocyanates and the sterically hindered diamines 1,3,5-triiso-propylbenzene-2,4-diamine and 1,3-diisopropylbenzene-2,4-diamine. It is also possible at the same time to use primary monoamines with an aliphatic, cycloaliphatic, and heterocyclic structure, having from 1 to 25 or even more carbon atoms. Also suitable are secondary monoamines with an aliphatic or cycloaliphatic structure, such as dibutylamine or dicyclohexylamine. Sterically hindered monoamines, however, are not used.

Here and below, “steric hindrance” means the spatial shielding of a primary or secondary amino group by at least one bulky organic radical which reduces the accessibility of the amino group to coreactants.

The known rheological aids already have a pronounced pseudoplasticity but this must, however, be improved further in order to satisfy the heightened requirements of the market. The coating materials comprising these known rheological aids may be applied at comparatively high coat thicknesses. Their tendency to form runs following application and in the course of curing is markedly reduced relative to that of coating materials which contain no rheological aids. To put it another way, their steadfastness is greater. This, too, must be developed further in order to satisfy the growing requirements of the market. In particular, it should be possible to set the pseudoplasticity of coating materials with smaller amounts of rheological aids, in order to prevent their known adverse effects, such as the formation of turbidities in the coating materials and the coatings produced from them, for instance.

It is an object of the present invention to find a novel rheological aid based on urea derivatives that has a more pronounced pseudoplasticity than the known rheological aids and which allows an advantageous pseudoplasticity to be set with smaller amounts of rheological aids, so that adverse effects are no longer induced.

The invention accordingly provides the novel rheological aid comprising at least one urea derivative preparable by reacting

(A) at least one compound containing at least one isocyanate group with

(B) at least one coreactant selected from the group consisting of sterically hindered primary and secondary monoamines.

In the text below, the novel rheological aid comprising at least one urea derivative is referred to as the “rheological aid of the invention”.

The invention also provides the novel process for preparing rheological aids comprising at least one urea derivative, which comprises reacting

(A) at least one compound containing at least one isocyanate group with

(B) at least one coreactant selected from the group consisting of sterically hindered primary and secondary monoamines

in an organic medium.

In the text below, the novel process for preparing rheological aids comprising at least one urea derivative is referred to as the “process of the invention”.

The invention further provides for the use of the rheological aids of the invention for preparing novel coating materials, adhesives, and sealing compounds.

Further subject matter of the invention will emerge from the following description.

In the light of the prior art it was surprising and unforeseeable for the skilled worker that the object on which the present invention was based could be achieved with the aid of the rheological aids of the invention and of the process of the invention. A particular surprise was that the novel rheological aids could be prepared reproducibly, simply, and reliably by means of the process of the invention.

Especially surprising was the fact that the rheological aids of the invention had a particularly pronounced pseudoplasticity, which exceeded that of known rheological aids, and were extremely widely applicable. They gave coating materials, adhesives, and sealing compounds, but especially coating materials, which had particularly high storage, transit, and circulation stability, were easy to apply, and exhibited very little if any tendency to run on vertical surfaces. The coatings produced from them showed excellent leveling and had no surface structures such as orange peel, craters or pinholes. The coatings were highly brilliant.

In view of the fact that the urea derivatives were prepared using monoamines whose reactive centers were sterically shielded and thus slower to react than monoamines without steric hindrance, these results are all the more surprising. Indeed, it was rather to have been expected that this hindrance of the reaction of the amino groups with the isocyanate groups would result in the formation of products having not very good properties.

The rheological aid of the invention comprises at least one urea derivative.

The amount of the urea derivatives in the rheological aid of the invention may vary widely and is guided in particular by the target rheology of the coating materials, adhesives, and sealing compounds of the invention. Preferably, the rheological aid of the invention comprises the urea derivatives in an amount, based on the rheological aid, of from 0.1 to 10%, more preferably from 0.2 to 9%, with particular preference from 0.3 to 8%, with very particular preference from 0.4 to 7%, and in particular from 0.5 to 6% by weight.

The urea derivatives for use in accordance with the invention are prepared using at least one compound (A) containing at least one isocyanate group. The compound (A) is selected from the group consisting of monoisocyanates and polyisocyanates. The polyisocyanates (A) are preferably diisocyanates.

Examples of suitable monoisocyanates are ethyl, propyl, butyl, pentyl, hexyl, heptyl, octyl, nonyl, decyl, undecyl, lauryl, cyclohexyl or phenyl isocyanate.

Examples of suitable diisocyanates (A) are tetramethylene 1,4-diisocyanate, hexamethylene 1,6-diisocyanate, 2,2,4-trimethylhexamethylene 1,6-diisocyanate, omega, omega′-dipropyl ether diisocyanate, cyclohexyl 1,4-diisocyanate, cyclohexyl 1,3-diisocyanate, cyclohexyl 1,2-diisocyanate, dicyclohexylmethane 4,4′-diisocyanate, 1,5-dimethyl-2,4-di(isocyanatomethyl)benzene, 1,5-dimethyl-2,4-di(isocyanatoethyl)benzene, 1,3,5-trimethyl-2,4-di(isocyanatomethyl)benzene, 1,3,5-triethyl-2,4-di(isocyanatomethyl)benzene, isophorone diisocyanate, dicyclohexyldimethylmethane 4,4′-diisocyanate, 2,4-tolylene diisocyanate, 2,6-tolylene diisocyanate, and diphenylmethane 4,4′-diisocyanate.

Examples of suitable polyisocyanates (A) are triisocyanates such as nonane triisocyanate (NTI) and also polyisocyanates (A) based on the above-described diisocyanates and triisocyanates (A), especially oligomers containing isocyanurate, biuret, allophanate, iminooxadiazinedione, urethane, carbodiimide, urea and/or uretdione groups. Examples of suitable polyisocyanates (A) of this kind and also processes for preparing them are known, for example, from the patents and patent applications CA 2,163,591 A1, U.S. Pat. No. 4,419,513 A, U.S. Pat. No. 4,454,317 A, EP 0 646 608 A1, U.S. Pat. No. 4,801,675 A, EP 0 183 976 A1, DE 40 15 155 A1, EP 0 303 150 A1, EP 0 496 208 A1, EP 0 524 500 A1, EP 0 566 037 A1, U.S. Pat. No. 5,258,482 A, U.S. Pat. No. 5,290,902 A, EP 0 649 806 A1, DE 42 29 183 A1 and EP 0 531 820 A1.

It is preferred to use the oligomers (A) of hexamethylene diisocyanate and of isophorone diisocyanate.

The above-described oligomers (A) advantageously have an NCO functionality of 2.0-5.0, preferably of 2.2-4.0, in particular of 2.5-3.8.

Also suitable are the high-viscosity polyisocyanates (A) as described in the German patent application DE 198 28 935 Al, and also the polyisocyanates (A) known from the German patent application DE 199 24 170 A1, column 2 lines 6 to 34, column 4 line 16 to column 6 line 62. For further details, refer to the international patent applications WO 00/31194, page 11 line 30 to page 12 line 26, and WO 00/37520, page 5 line 4 to page 6 line 27.

To prepare the urea derivatives, the above-described compounds (A) are reacted with at least one coreactant (B) selected from the group consisting of sterically hindered primary and secondary monoamines.

The sterically hindered monoamines (B) are preferably selected from the group consisting of aliphatic, cycloaliphatic, aromatic, and heteroaromatic sterically hindered primary monoamines and also aliphatic-aliphatic, aliphatic-cycloaliphatic, aliphatic-aromatic, aliphatic-heteroaromatic, cycloaliphatic-cycloaliphatic, cycloaliphatic-aromatic, cycloaliphatic-heteroaromatic, aromatic-aromatic, aromatic-heteroaromatic, heteroaromatic-heteroaromatic, and saturated and unsaturated heterocyclic sterically hindered secondary monoamines (B).

A primary monoamine (B) is referred to, for example, as aliphatic or cycloaliphatic monoamine (B) if the amino group is connected directly to an aliphatic or cycloaliphatic radical. This nomenclature rule is to apply correspondingly to the other sterically hindered primary monoamines (B).

A sterically hindered secondary monoamine (B) is referred to, for example, as aliphatic-cycloaliphatic or cycloaliphatic-aromatic if its nitrogen atom is connected to an aliphatic and a cycloaliphatic radical or to a cycloaliphatic and an aromatic radical. This nomenclature rule is to apply correspondingly to the other sterically hindered secondary-monoamines (B).

Preferably, the sterically blocking radicals are selected from the group consisting of monovalent, substituted and unsubstituted, aliphatic, cycloaliphatic, aromatic, and heteroaromatic radicals and also substituted and unsubstituted, cycloaliphatic, aromatic, and heteroaromatic rings which are fused to a polycyclic parent structure.

Examples of suitable aliphatic sterically blocking radicals are alkyl radicals having from 1 to 10 carbon atoms, such as methyl, ethyl, propyl, isopropyl, n-butyl, isobutyl, tert-butyl, pentyl, amyl, neopentyl, hexyl, heptyl, octyl, nonyl and decyl, especially methyl.

Examples of suitable cycloaliphatic sterically blocking radicals are cycloalkyl radicals having from 4 to 8 carbon atoms, such as cyclobutyl, cyclopentyl, cyclohexyl, cycloheptyl and cyclooctyl, especially cyclohexyl.

Examples of suitable aromatic sterically blocking radicals are phenyl, biphenylyl and naphthyl, especially phenyl.

Examples of suitable heteroaromatic sterically blocking radicals (heteroaryl) are pyridyl, quinolyl, isoquinolyl, acridinyl, pyridazinyl, pyrimidinyl, pyrazinyl or triazinyl, especially pyridyl and triazinyl.

Where an amino group is shielded only by one sterically blocking or hindering radical, it has at least two, preferably at least three carbon atoms. Where the radicals in question are aliphatic radicals, they are preferably branched. Examples of suitable radicals of this kind are isopropyl, tert-butyl or neopentyl.

Examples of suitable polycyclic, especially bicyclic and tricyclic, parent structures to which at least one cycloaliphatic, aromatic or heteroaromatic, particularly aromatic, ring is fused in such a way that it sterically blocks the amino group are naphthalene, quinoline, isoquinoline, acridinyl, anthracene, and phenanthrene, especially naphthalene.

Particularly in their parent systems and/or in their sterically blocking radicals, the primary and secondary sterically hindered monoamines (B) may carry substituents other than the monovalent organic radicals described above. Owing to the incorporation of substituents it is possible to tailor the properties of the urea derivatives and thus of the rheological aids of the invention.

The substituents are preferably inert. In the context of the present invention, “inert” means that the substituents in question, under the conditions of the reaction of (A) with (B), do not initiate and/or enter into any reactions, or only such reactions as are very slow in comparison to the reaction of the amino groups with the isocyanate groups.

Preferably, the substituents are selected from the group consisting of fluorine, chlorine and bromine atoms and also hydroxyl, nitrile, nitro, ether and carboxylic acid, sulfonic acid and phosphonic acid ester groups.

With particular preference, the urea derivatives do not carry any substituents.

The above-described monoamines (B) are preferably selected from the group consisting of the monoamines of the general formulae (B I) to (B XI):

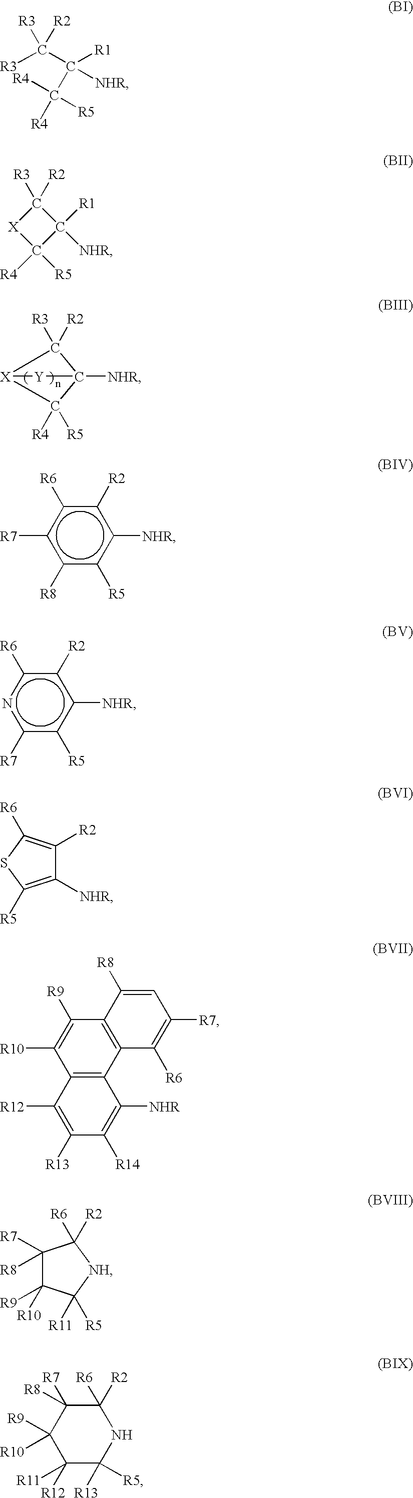

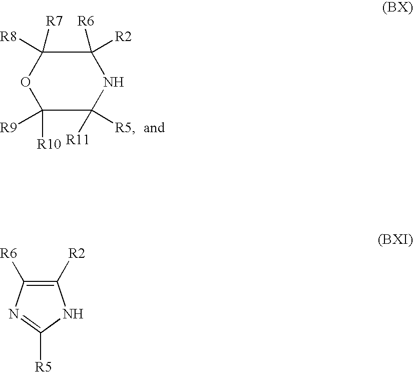

in which the index n in the general formula (B III) and the variables in the general formulae (B I) to (B XI) have the following meanings:

B I:

R hydrogen atom, alkyl of 1 to 10 carbon atoms, cycloalkyl of 4 to 8 carbon atoms, aryl of 6 to 12 carbon atoms, heteroaryl of 2 to 12 carbon atoms, especially the above-described aliphatic, cycloaliphatic, aromatic, and heteroaromatic radicals;

R1, R3 and R4 like R or inert substituent, preferably the above-described inert substituents, especially fluorine, chlorine, and bromine atoms and also nitrile, nitro, ether and carboxylic acid, sulfonic acid and phosphonic acid ester groups;

R2 and R5 independently of one another like R, except for hydrogen atom, unless R2 or R5 stands for a radical R having at least two, preferably at least three carbon atoms;

B II:

R and R2 to R5 independently of one another the meaning indicated for B I, especially R2 and R5 =alkyl, preferably methyl, and R3 and R4 =hydrogen atoms;

R1 the meaning indicated for B I;

X divalent, aliphatic, substituted or unsubstituted radical containing at least one heteroatom or no heteroatom, preferably methylene, ethylene (dimethylene), trimethylene, tetramethylene, 1-oxaethane-1,2-diyl or 2-oxapropane-1,3-diyl, preferably methylene, dimethylene or trimethylene, especially trimethylene;

B III:

R and R2 to R5 independently of one another the meaning indicated for B I;

X the meaning indicated for B II;

Y divalent radical X having the meaning indicated for B II;

n 1 or 2;

B IV:

R, R2 and R5 independently of one another the meaning indicated for B I;

R6 to R8 independently of one another the meaning indicated for R1 in B I, or R6 and R7 and R7 and R8 linked cyclically to one another;

B V:

R, R2 and R5 independently of one another the meaning indicated for B I;

R6 and R7 independently of one another the meaning indicated for B IV;

B VI:

R, R2 and R5 independently of one another the meaning indicated for B I;

B VII:

R the meaning indicated for B I;

R6 to R13 independently of one another the meaning indicated for R1 in B I or R6 and R7, R7 and R8, R8 and R9, R9 and R10, R10 and R11, R11 and R12 and/or R12 and R13 linked cyclically to one another;

B VIII:

R2 and R5 independently of one another the meaning indicated for B I;

R6 to R11 independently of one another the meaning indicated for R1 in B I, or R6 and R7, R7 and R8, R8 and R9, R9 and R10, R10 and R11, R6 and R8, R6 and R9, R6 and R10, R6 and R11, R7 and R9, R7 and R10, R7 and R11, R8 and R10 and/or R8 and R11 and/or, where R2 is different from R5, R9 and R11 linked cyclically to one another;

B IX:

R2 and R5 independently of one another the meaning indicated for B I;

R6 to R13 independently of one another the meaning indicated for R1 in B I, or R6 and R7, R7 and R8, R8 and R9, R9 and R10, R10 and R11, R11 and R12 and/or R12 and R13, R6 and R8, R6 and R9, R6 and R10, R6 and R11, R6 and R12, R6 and R13, R7 and R9, R7 and R10, R7 and R11, R7 and R12, R7 and R13, R8 and R10, R8 and R11, R8 and R12, R8 and R13 and/or, where R2 is different from R5, R9 and R11, R9 and R12 and/or R9 and R13 linked cyclically to one another;

B X:

R2 and R5 independently of one another the meaning indicated for B I;

R6 to R11 independently of one another the meaning indicated for R1 in B I, or R6 and R7, R7 and R8, R8 and R9, R9 and R10, R10 and R11, R6 and R8, R6 and R9, R6 and R10, R6 and R11, R7 and R9, R7 and R10, R7 and R11, R8 and R10 and/or R8 and R11 and/or, where R2 is different from R5, R9 and R11 linked cyclically to one another;

B XI:

R2 and R5 independently of one another the meaning indicated for B I;

R6 the meaning indicated for R1 in B I.

Examples of suitable monoamines (B) of the general formulae (B I) to (B XI) are 3-amino-2,2,4,4-tetramethylpentane, 2-amino-1,1,3,3-tetraphenylpropane, 1-amino-2,2,6,6-tetramethylcyclohexane, 2,6-dimethylcyclohexylamine, 2-tert-butylcyclohexylamine, 1-amino-2,6-dimethyloxane, 3-amino-2,4-dimethyltetrahydrofuran, 1-amino-2,6-diphenylnorbornane, 1-amino-2,6-diphenylbicyclo[2.2.2]octane, 2,6-dimethylaniline, 2,6-diethylaniline, 4-chloro-2,6-dimethylaniline, 2-ethylaniline, 2-isopropylaniline, 2-tert-butylaniline, 4-amino-3,5-diethylpyridine, 3-amino-2,4-dimethylthiophene, 4-amino-5-methylphenanthrene, 2,5-dimethylazetidine, 2,6-dimethylazinane, 2,6-dimethylmorpholine, or 2,5-dimethylimidazole, especially 2,6-dimethylcyclohexylamine.

The starting products (A) and (B) are preferably reacted with one another in amounts such that the equivalent ratio of isocyanate groups in (A) to the isocyanate-reactive groups in (B) is from 2:1 to 1:2, more preferably from 1.8:1 to 1:1.8, with particular preference from 1.6:1 to 1:1.6, with further particular preference from 1.4:1 to 1:1.4, and in particular from 1.2:1 to 1:1.2.

The above-described starting products (A), on the one hand, and (B), on the other, may be combined as desired for the reaction. Particularly advantageous urea derivatives and rheological aids of the invention are produced if (A) is at least one diisocyanate and (B) is at least one monoamine.

Besides the above-described sterically hindered monoamines and polyamines (B) for use in accordance with the invention, it is also possible to use, in minor amounts, water and also customary and known monoamines and polyamines for the reaction with the mono- and polyisocyanates (A). “Minor amounts” means that the amounts of water and/or customary and known monoamines and polyamines used are only such that the profile of properties of the urea derivatives in question, for use in accordance with the invention, is determined primarily by the sterically hindered monoamines (B) for use in accordance with the invention.

Examples of suitable customary and known monoamines are known from the German patent applications DE 199 24 172 A1, page 3 lines 3 to 10, and DE 199 24 171 A1, page 3 lines 35 to 42, or from the international patent applications WO 00/31194, page 11 lines 14 to 29, and WO 00/37520, page 3 line 15, to page 4 line 5. Particular preference is given to using methoxypropylamine, benzylamine and/or n-hexylamine.

The customary and known polyamines may be selected from the group consisting of aliphatic, cycloaliphatic, aromatic, aliphatic-aromatic, cycloaliphatic-aromatic and aliphatic-cycloaliphatic polyamines. The polyamines preferably contain primary or primary and secondary amino groups. The nomenclature rules recited above are to apply here correspondingly.

The customary and known polyamines may preferably be selected from the group consisting of aliphatic and cycloaliphatic polyamines. Examples of suitable customary and known polyamines are known from the international patent application WO 00/37520, page 4 lines 6 to 19, or from the German patent DE 23 59 923, column 5 line 55, to column 6 line 27 and column 7 lines 35 to 61.

The reaction of (A) with (B) takes place preferably in an organic medium, using amounts of (A) and (B) which result in the above-described amount of urea derivatives in the rheological aids of the invention.

The organic medium may comprise at least one organic solvent. The organic solvents are preferably selected from the solvents described in D. Stoye and W. Freitag (Editors), “Paints, Coatings and Solvents”, Second, Completely Revised Edition, Wiley-VCH, Weinheim, N.Y., 1998, “14.9. Solvent Groups”, pages 327 to 373.

The organic medium may further comprise at least one compound selected from the group consisting of low molecular mass, oligomeric, and polymeric compounds curable thermally, with actinic radiation, and thermally and with actinic radiation (dual cure).

The low molecular mass compounds are preferably selected from the group consisting of reactive diluents curable thermally and with actinic radiation and cross-linking agents curable thermally, or thermally and with actinic radiation, and the oligomeric and polymeric compounds are preferably selected from the group consisting of random, alternating and block, linear, branched and comb addition (co)polymers or olefinically unsaturated monomers, and also polyaddition resins and polycondensation resins, which are curable thermally, with actinic radiation, and thermally and with actinic radiation (dual cure).

Critical to the selection is that the above-described organic solvents and compounds do not disrupt the reaction between the starting products (A) and (B) by reacting, for instance, more rapidly with the polysocyanates (A) than do the monomers (B).

Examples of suitable thermally curable reactive diluents are described in the German patent applications DE 198 09 643 A1, DE 198 40 605 A1 and DE 198 05 421 A1 and examples of suitable reactive diluents curable with actinic radiation are described in Römpp Lexikon Lacke und Druckfarben, Stuttgart, N.Y., 1998, pages 491 and 492.

Here and below, actinic radiation means electromagnetic radiation, such as near infrared (NIR), visible light, UV radiation and X-rays, especially UV radiation, and corpuscular radiation, such as electron beams.

Examples of suitable crosslinking agents curable thermally, or thermally and with actinic radiation, are amino resins, as described for example in Römpp Lexikon Lacke und Druckfarben, Georg Thieme Verlag, 1998, page 29, “amino resins”, in the textbook “Lackadditive” [Additives for coatings) by Johan Bieleman, Wiley-VCH, Weinheim, N.Y., 1998, pages 242 ff., in the book “Paints, Coatings and Solvents”, second, completely revised edition, editors D. Stoye and W. Freitag, Wiley-VCH, Weinheim, N.Y., 1998, pages 80 ff., in the patents U.S. Pat. No. 4,710,542 A and EP 0 245 700 A1, and in the article by B. Singh and coworkers, “Carbamylmethylated Melamines, Novel Crosslinkers for the Coatings Industry”, in Advanced Organic Coatings Science and Technology Series, 1991, volume 13, pages 193 to 207; carboxyl-containing compounds or resins, as described for example in the patent DE 196 52 813 A1; compounds or resins containing epoxide groups, as described for example in the patents EP 0 299 420 A1, DE 22 14 650 B1, DE 27 49 576 B1, U.S. Pat. Nos. 4,091,048 A and 3,781,379 A; excess polyisocyanates (A) as described above; fully blocked polyisocyanates (A); fully blocked isocyanato (meth)acrylates in accordance with the European patent application EP 0 928 800 A1, such as are described in the German patent application DE 100 41 635.7, unpublished at the priority date of this present specification; and/or tris(alkoxycarbonylamino)triazines, such as are known from the patents U.S. Pat. Nos. 4,939,213 A, 5,084,541 A, 5,288,865 A and EP 0 604 922 A.

Examples of suitable addition (co)polymers, polyaddition resins and polycondensation resins are known, for example, from the German patent application DE 199 24 172 A1, page 3 line 33 to page 5 line 21, the German patent application DE 199 24 171 A1, page 5 line 48 to page 7 line 37, or the German patent application DE 199 08 013 A1, column 5 line 44 to column 8 line 65 and column 9 lines 25 to 67.

The urea derivatives may be prepared in the presence of at least one surface-active substance.

Surface-active substances are compounds which, in solution or dispersion in a liquid, are adsorbed preferentially at an interface and thereby reduce the interfacial tension or, in the case of liquid systems, the surface tension. The molecules of the surface-active substances possess at least one group with an affinity for surfaces of pronounced polarity, and also a radical which shows little affinity for water (cf. Römpp Lexikon Lacke und Druckfarben, Georg Thieme Verlag, Stuttgart, N.Y., 1998, “surface-active substances”, page 271).

The surface-active substances are preferably selected from the group consisting of ionic and nonionic, low molecular mass, oligomeric and high molecular mass surfactants. Examples of suitable surfactants of this kind are described, for example, in Römpp Lexikon Lacke und Druckfarben, Georg Thieme Verlag, Stuttgart, N.Y., 1998, “surfactants”, page 557, and “nonionic surfactants”, page 410.

Preference is given to using wetting agents as defined by Römpp Lexikon Lacke und Druckfarben, Georg Thieme Verlag, Stuttgart, N.Y., 1998, “wetting agents”, page 409.

Suitable wetting agents are described in Johan Bieleman, “Lackadditive”, Wiley-VCH, Weinheim, N.Y., 1998, “4 Surface-active compounds”, pages 69 to 100, especially “4.1.4 Chemical composition of wetting and dispersing agents”, pages 87 to 92, and “4.1.8 Commercial products”, page 100, or in the German patent application DE 199 24 171 A1, page 2 line 63 to page 3 line 24.

Examples of highly suitable wetting agents include the following commercial products

Texaphor® 963 from Cognis (low molecular mass electroneutral salt of a polycarboxylic acid with amine derivatives, 50 percent in higher aromatics),

Texaphor® 3112 from Cognis (high molecular mass polyurethane, 50 percent in xylene/butyl acetate 2:3),

Disperbyk® 110 from Byk Chemie (anionic copolymer containing acidic groups, acid number: 53 mg KOH/g, 50 percent in methoxypropyl acetate/alkylbenzene 1:1),

Disperbyk® 161 from Byk Chemie (high molecular mass polyurethane, amine number: 11 mg KOH/g, 30 percent in methoxypropyl acetate/butyl acetate 6:1),

Disperbyk® 166 from Byk Chemie (high molecular mass polyurethane, amine number: 20 mg KOH/g, 30 percent in butyl acetate/methoxypropyl acetate 4:1),

Efka® 4163 from Efka (high molecular mass polyurethane, amine number: 11 mg KOH/g, 30 percent in methoxypropyl acetate/butyl acetate 6:1) and

Efka® 4047 from Efka (high molecular mass polyurethane, amine number: 10-20 mg KOH/g, 35 percent in butyl acetate/methoxypropyl acetate/secondary-butanol).

The wetting agents are used preferably in an amount of from 0.1 to 15%, more preferably from 0.2 to 13%, with particular preference from 0.3 to 12%, with very particular preference from 0.4 to 11%, and in particular from 0.5 to 10% by weight, based in each case on the overall amount of wetting agent and starting products (A) and (B).

The reaction of the starting products (A) and (B) has no special features in terms of its method but instead is carried out, for example, as described in the German patent application DE 199 24 171 A1, page 5 lines 35 to 40, the German patent application DE 199 24 172 A1, page 3 lines 22 to 27, or the international patent application WO 00/31194, page 12 line 23 to page 13 line 19. The reaction in the presence of amino resins, for example, takes place as described in the international patent application WO 00/37520, page 6 line 29 to page 8 line 14 and page 9 line 28 to page 10 line 32.

For the preparation of the urea derivatives and of the rheological aids of the invention on the tonne scale, an advantageous process is the continuous process known from the German patent application DE 199 03 283 A1, in which an inline dissolver is used as the mixing unit. In this case the weight ratio of above-described compound to the urea derivatives may be 100:1, preferably 90:1, more preferably 80:1, with particular preference 70:1, with very particular preference 60:1, and in particular 50:1.

Besides the above-described urea derivatives for use in accordance with the invention and the other constituents, the rheological aids of the invention may further comprise at least one modified, pyrogenic silica as described, for example, in the German patent application DE 199 24 172 A1, page 3 lines 28 to 32.

The rheological aids of the invention have a particularly pronounced pseudoplasticity.

The rheological aids of the invention are extremely widely applicable and in particular are outstandingly suited to producing coating materials, adhesives, and sealing compounds. The coating materials, adhesives, and sealing compounds of the invention may be curable physically, thermally, with actinic radiation, and thermally and with actinic radiation (dual cure).

Besides the rheological aid of the invention, the coating materials, adhesives, and sealing compounds of the invention may comprise, for example, the constituents described in detail in the German patent application DE 199 24 171 A1, page 5 line 47, to page 9 line 32. The coating materials, adhesives, and sealing compounds may be prepared by the process described in this German patent application on page 9 lines 33 to 54. Examples of suitable substrates and coating techniques are likewise described in the German patent application on page 9 line 55 to page 10 line 23. Examples of suitable processes for thermal curing and for curing with actinic radiation are known, for example, from the international patent application WO 98/40170, page 17 line 18 to page 19 line 20, or the German patent application DE 198 18 713 A1, column 10 line 31, to column 11 line 33.

The pseudoplastic coating materials of the invention are used in particular as clearcoat materials and/or as color and/or effect coating materials for the production of clearcoat systems and also single-coat or multicoat, color and/or effect, electrically conductive, magnetically shielding and/or fluorescent coatings.

The stability of the pseudoplastic coating materials, adhesives, and sealing compounds of the invention under static and dynamic conditions, especially the circulation stability, and also the running behavior on application and curing, are outstanding.

Accordingly, the pseudoplastic coating materials, adhesives, and sealing compounds of the invention are outstandingly suitable for coating, bonding, and sealing motor vehicle bodies, parts of motor vehicle bodies, motor vehicles inside and out, buildings inside and out, doors, windows, and furniture, and also for coating, bonding, and sealing as part of the industrial coating of, for example, small parts such as nuts, screws, wheel rims or hubcaps, coils, containers, packaging, electrical components, such as motor windings or transformer windings, and white goods, such as domestic appliances, boilers, and radiators.

The coatings of the invention produced from the pseudoplastic coating materials of the invention are hard, scratch-resistant, weathering-stable, chemically stable, and above all of an extremely high brilliance.

The adhesive films produced from the pseudoplastic adhesives of the invention durably connect a very wide variety of substrates bonded using them. Even under extreme climatic conditions and/or highly fluctuating temperatures, there is no loss of bond strength.

The seals produced from the pseudoplastic sealing compounds of the invention durably seal the substrates sealed using them, even in the presence of strongly aggressive chemicals.

Accordingly, the substrates coated with the coatings of the invention, bonded with the adhesive films of the invention and/or sealed with the seals of the invention possess an extremely long service life and a particularly high utility, which makes them particularly economic in production and use.

### INVENTIVE AND COMPARATIVE EXAMPLES

### Preparation Example 1

The Preparation of the Solution of a Thermally Curable Methacrylate Copolymer 1

813 parts by weight of an aromatic hydrocarbon fraction having a boiling range of 158-172° C. were weighed into an appropriate reactor equipped with a stirrer, two dropping funnels for the monomer mixture and the initiator solution, a nitrogen inlet pipe, a thermometer and a reflux condenser. The solvent was heated to 140° C. After it had reached 140° C., a monomer mixture of 483 parts by weight of n-butyl methacrylate, 663 parts by weight of styrene, 337 parts by weight of hydroxyethyl methacrylate and 31 parts by weight of methacrylic acid was metered into the reactor at a uniform rate over the course of 4 hours, and an initiator solution of 122 parts by weight of t-butyl perethylhexanoate in 46 parts by weight of the above-described aromatic solvent was metered into the reactor at a uniform rate over the course of 4.5 hours. The additions of the monomer mixture and of the initiator solution were commenced simultaneously. After the end of the initiator feed, the reaction mixture was held at 140° C. for two more hours and then cooled. The resulting polymer solution had a solids content of 65%, determined in a forced air oven (1 h at 130° C.).

The solution of the methacrylate copolymer 1 was used as an organic medium for preparing the inventive rheological aid of example 2

### Preparation Example 2

The Preparation of the Solution of a Thermally Curable Methacrylate Copolymer 2

897 parts by weight of an aromatic hydrocarbon fraction having a boiling range of 158-172° C. were weighed into an appropriate reactor equipped with a stirrer, two dropping funnels for the monomer mixture and initiator solution respectively, a nitrogen inlet pipe, a thermometer and a reflux condenser. The solvent was heated to 140° C. After it had reached 140° C., a monomer mixture of 487 parts by weight (corresponding to 34% by weight, based on the monomer mixture) of t-butyl acrylate, 215 parts by weight (corresponding to 15% by weight, based on the monomer mixture) of n-butyl methacrylate, 143 parts by weight (10% by weight, based on the monomer mixture) of styrene, 572 parts by weight (40% by weight, based on the monomer mixture) of hydroxypropyl methacrylate and 14 parts by weight (1% by weight, based on the monomer mixture) of acrylic acid was metered into the reactor at a uniform rate over the course of 4 hours, and an initiator solution of 86 parts by weight of t-butyl perethylhexanoate in 86 parts by weight of the above-described aromatic solvent was metered into the reactor at a uniform rate over the course of 4.5 hours. The additions of the monomer mixture and of the initiator solution were commenced simultaneously. After the end of the initiator feed, the reaction mixture was held at 140° C. for two more hours and then cooled. The resulting polymer solution, diluted with a mixture of 1-methoxypropyl 2-acetate, butyl glycol acetate and butyl acetate, had a solids content of 54%, determined in a forced air oven (1 h at 130° C.), a hydroxyl number of 155 mg KOH/g solids, an acid number of 10 mg KOH/g solids and a viscosity of 23 dPas (measured on a 60% dilution of the polymer solution in the above-described aromatic solvent using an ICI cone and plate viscometer at 23° C.). The methacrylate copolymer 2 had a glass transition temperature Tg of 67° C.

The methacrylate copolymer 2 was used as a binder.

### Preparation example 3

The Preparation of the Solution of a Thermally Curable Methacrylate Polymer 3

Preparation example 2 was repeated but replacing the monomer mixture used therein by a monomer mixture comprising, based on the monomer mixture,

23% by weight of 2-ethylhexyl methacrylate,

11.1% by weight of 2-ethylhexyl acrylate,

19.25% by weight of n-butyl methacrylate,

46.1% by weight of hydroxypropyl methacrylate, and

0.25% by weight of acrylic acid.

The polymer solution had a solids content of 65%, determined in a forced air oven (1 h at 130° C.), a hydroxyl number of 179 mg KOH/g solids, an acid number of 10 mg KOH/g solids and a viscosity of 7 dPas (measured on a 60% dilution of the polymer solution in the above-described aromatic solvent using an ICI cone and plate viscometer at 23° C.).

The methacrylate copolymer 3 was used as a binder.

### Preparation Example 4

The Preparation of a Polyisocyanate-based Crosslinking Agent

The crosslinking agent was prepared by mixing

54.8 parts by weight of a 90% dilution of the isocyanurate-type trimer of hexamethylene diisocyanate in solvent naphtha/butyl acetate 1:1 (Desmodur® N 3390 from Bayer AG),

35.2 parts by weight of the isocyanurate-type trimer of isophorone diisocyanate (Desmodur® Z4470, 70% strength, from Bayer AG), and

10 parts by weight of butyl acetate.

### INVENTIVE EXAMPLE 1 AND COMPARATIVE EXAMPLE C1

The Preparation of the Inventive Rheological Aid 1 and of the Noninventive Rheological Aid C1

### Inventive Example 1

In an internally coated can of suitable size, a premix was formed from 24 parts by weight of 2,6-dimethylcyclohexylamine and 480 parts by weight of butyl acetate, and homogenized using a dissolver. With the dissolver running, a solution of 15.8 parts by weight of hexamethylene diisocyanate and 102 parts by weight of butyl acetate was metered into this initial charge over the course of two minutes. The resulting reaction mixture was dispersed using a dissolver for ten minutes.

### Comparative example C1

Example 1 was repeated but replacing 2,6-dimethylcyclohexylamine by an equivalent amount of benzylamine.

Table 1 compares the pseudoplasticity of rheological aid 1 with that of rheological aid C1. The comparison shows that the inventive rheological aid 1 has a more pronounced pseudoplasticity than the noninventive rheological aid C1.

TABLE 1
The pseudoplasticity of rheological aids 1
and C1

Viscosity (mPas) at
shear rate (1/s):

| Example | 1 | 10 | 100 | 1 000 |
|---|---|---|---|---|
| 1 | 4.010 | 1.560 | 254.5 | 28.7 |
| C1 | 3.500 | 1.090 | 388 | 66.7 |

### INVENTIVE EXAMPLE 2

The Preparation of the Inventive Rheological Aid 2

In a glass beaker of appropriate size, 480 parts by weight of the solution of the methacrylate copolymer 1 from preparation example 1 and 11.6 parts by weight of 2.6-dimethylcyclohexylamine were introduced. 7.6 parts by weight of hexamethylene diisocyanate were metered into the initial charge over the course of 5 minutes with vigorous stirring using a laboratory dissolver. The reaction mixture was stirred intensively for 15 minutes more. The resulting rheological aid 2 had a solids content of 66% by weight, determined in a forced air oven (1 h at 130° C.).

The inventive rheological aid 2 exhibited an outstanding pseudoplasticity.

### INVENTIVE EXAMPLE 3 AND COMPARATIVE EXAMPLE C2

The Preparation of an Inventive Two-component Clearcoat Material and Production of an Inventive Clearcoat (Example 3), and the Preparation of a Noninventive Two-component Clearcoat Material and Production of a Noninventive Clearcoat (Example C2)

The inventive (example 3) and noninventive (example C2) two-component clearcoat materials were prepared by mixing and homogenizing the constituents listed in table 2. In the case of example C2, a commercially customary rheological aid comprising a benzylamine-based urea derivative was used.

TABLE 2
Material composition of the two-component
clearcoat materials of example 3 and of
example C2, and their properties

| | | Example |
|---|---|---|
| Constituent | Example 3 | C2 |
| Binder component: | | |
| methacrylate copolymer 3 from | 50 | 50 |
| preparation example 3 | | |
| Setalux ® 81753 from Akzo | — | 16 |
| (commercial rheological aid) | | |
| inventive rheological aid 2 | 16 | — |
| from example 2 | | |
| methacrylate copolymer 2 from | 10 | 10 |
| preparation example 2 | | |
| GB ester (butyl glycolate) | 5 | 5 |
| Tinuvin ® 400 (commercial UV | 1.2 | 1.2 |
| absorber) | | |
| butyl glycol acetate | 5.9 | 5.9 |
| Tinuvin ® 292 (commercial | 1 | 1 |
| reversible free-radical | | |
| scavenger) | | |
| butanol | 1.6 | 1.6 |
| Byk ® ES 80 (commercial wetting | 0.2 | 0.2 |
| agent) | | |
| xylene | 1.6 | 1.6 |
| dibasic ester (commercial | 2 | 2 |
| mixture of the dimethyl esters | | |
| of glutaric, adipic, and | | |
| sebacic acid) | | |
| Byk ® 325 (commercial leveling | 0.2 | 0.2 |
| agent) | | |
| butyl glycol acetate | 5.3 | 5.3 |
| Crosslinking component: | | |
| crosslinking agent from | 50 | 50 |
| preparation example 4 | | |
| addition of butyl acetate to | 4.5 | 4.2 |
| give a spray viscosity of 25 to | | |
| 27 s in the DIN 4 efflux cup at | | |
| 23° C. (in % by weight) | | |
| Properties: | | |
| original viscosity in the DIN 4 | 38 | 34 |
| efflux cup at 23° C. | | |
| solids content at spray | 46.3 | 47.1 |
| viscosity (1 hour/125° C.) | | |
| air inclusions following | none | none |
| adjustment to spray viscosity | | |
| pseudoplasticity at | | |
| shear rate 10 1/s | 200 | 116 |
| shear rate 1 000 1/s | 88 | 84 |

The inventive two-component clearcoat material of example 3 had a more pronounced pseudoplasticity than the two-component clearcoat material of example C2.

To assess the running behavior (number and length of runs) and the brilliance, the two-component clearcoat materials of example 3 and of example C2 were applied as wedge films to customary and known, vertical perforated panels with a diagonal series of perforations, and were baked in a vertical position at 140° C. for 30 minutes. The running behavior and the brilliance were assessed visually.

In its running behavior and its brilliance, the inventive clearcoat (example 3) exceeded the noninventive clearcoat of example C2.

What is claimed is:

1. A rheological aid comprising at least one urea derivative preparable by reacting
(A) at least one compound containing at least one isocyanate group with
(B) at least one coreactant selected from the group consisting of sterically hindered primary and secondary monoamines.

2. The rheological aid as claimed in claim 1, wherein the compound (A) is selected from the group consisting of monoisocyanates and polyisocyanates.

3. The rheological aid as claimed in claim 2, wherein the polyisocyanates (A) are diisocyanates.

4. The rheological aid as claimed in any of claims 1 to 3, wherein the monoamines (B) are selected from the group consisting of aliphatic, cycloaliphatic, aromatic, and heteroaromatic primary monoamines and also aliphatic-aliphatic, aliphatic-cycloaliphatic, aliphatic-aromatic, aliphatic-heteroaromatic, cycloaliphatic-cycloaliphatic, cycloaliphatic-aromatic, cycloaliphatic-heteroaromatic, aromatic-aromatic, aromatic-heteroaromatic, heteroaromatic-heteroaromatic, and saturated and unsaturated heterocyclic secondary monoamines (B).

5. The rheological aid as claimed in any of claims 1 to 4, wherein the sterically blocking radicals are selected from the group consisting of monovalent, substituted and unsubstituted, aliphatic, cycloaliphatic, aromatic, and heteroaromatic radicals and also substituted and unsubstituted, cycloaliphatic, aromatic, and heteroaromatic rings which are fused to at least one polycyclic parent system.

6. The rheological aid as claimed in claim 5, wherein the substituents are inert.

7. The rheological aid as claimed in claim 6, wherein the substituents are selected from the group consisting of fluorine, chlorine and bromine atoms and also hydroxyl, nitrile, nitro, ether and carboxylic acid, sulfonic acid and phosphonic acid ester groups.

8. The rheological aid as claimed in any of claims 1 to 7, wherein the coreactants (A) are selected from the group of the diisocyanates.

9. The rheological aid as claimed in any of claims 1 to 8, wherein the monoamines (B) are selected from the group consisting of the monoamines of the general formula (B I) to (B XI): 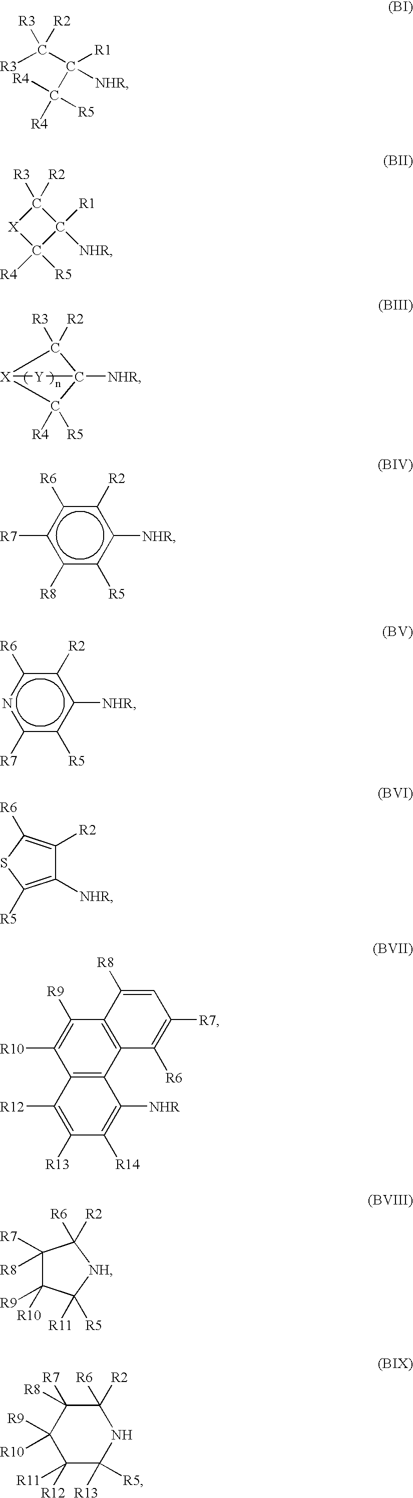 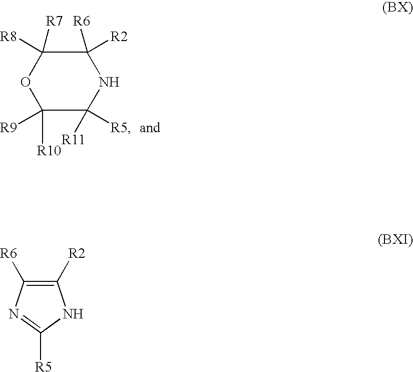
in which the index in the general formula (B III) and the variables in the general formulae (B I) to (B XI) have the following meanings:
B I:
R hydrogen atom, alkyl of 1 to 10 carbon atoms, cycloalkyl of 4 to 8 carbon atoms, aryl of 6 to 12 carbon atoms, heteroaryl of 2 to 12 carbon atoms;
R1, R3 and R4 like R or inert substituent;
R2 and R5 independently of one another like R, except for hydrogen atom, unless R2 or R5 stands for a radical R having at least two carbon atoms;
B II:
R and R2 to R5 independently of one another the meaning indicated for B I;
R1 the meaning indicated for B I;
X divalent, aliphatic, substituted or unsubstituted radical containing at least one heteroatom or no heteroatom;
B III:
R and R2 to R5 independently of one another the meaning indicated for B I;
X the meaning indicated for B II;
Y divalent radical X having the meaning indicated for B II;
n 1 or 2;
B IV:
R, R2 and R5 independently of one another the meaning indicated for B I;
R6 to R8 independently of one another the meaning indicated for R1 in B I, or R6 and R7 and R7 and R8 linked cyclically to one another;
B V:
R, R2 and R5 independently of one another the meaning indicated for B I;
R6 and R7 independently of one another the meaning indicated for B IV;
B VI:
R, R2 and R5 independently of one another the meaning indicated for B I;
B VII:
R the meaning indicated for B I;
R6 to R13 independently of one another the meaning indicated for R1 in B I or R6 and R7, R7 and R8, R8 and R9, R9 and R10, R10 and R11, R11 and R12 and/or R12 and R13 linked cyclically to one another;
B VIII:
R2 and R5 independently of one another the meaning indicated for B I;
R6 to R11 independently of one another the meaning indicated for R1 in B I, or R6 and R7,
R7 and R8, R8 and R9, R9 and R10, R10 and R11, R6 and R8, R6 and R9, R6 and R10, R6 and R11, R7 and R9, R7 and R10, R7 and R11, R8 and R10 and/or R8 and R11 and/or, where R2 is different from R5, R9 and R11 linked cyclically to one another;
B IX:
R2 and R5 independently of one another the meaning indicated for B I;
R6 to R13 independently of one another the meaning indicated for R1 in B I, or R6 and R7, R7 and R8, R8 and R9, R9 and R10, R10 and R11, R11 and R12 and/or R12 and R13, R6 and R8, R6 and R9, R6 and R10, R6 and R11, R6 and R12, R6 and R13, R7 and R9, R7 and R10, R7 and R11, R7 and R12, R7 and R13, R8 and R10, R8 and R11, R8 and R12, R8 and R13 and/or, where R2 is different from R5, R9 and R11, R9 and R12 and/or R9 and R13 linked cyclically to one another;
B X:
R2 and R5 independently of one another the meaning indicated for B I;
R6 to R11 independently of one another the meaning indicated for R1 in B I, or R6 and R7, R7 and R8, R8 and R9, R9 and R10, R10 and R11, R6 and R8, R6 and R9, R6 and R10, R6 and R11, R7 and R9, R7 and R10, R7 and R11, R8 and R10 and/or R8 and R11 and/or, where R2 is different from R5, R9 and R11 linked cyclically to one another;
B XI:
R2 and R5 independently of one another the meaning indicated for B I;
R6 the meaning indicated for R1 in B I.

10. The rheological aid as claimed in claim 9, wherein the monoamines (B) have the general formula (B II) in which X is a methylene, dimethylene or trimethylene radical.

11. The rheological aid as claimed in claim 10, wherein R is a hydrogen atom.

12. The rheological aid as claimed in claim 10 or 11, wherein R2 and R5 are alkyl radicals.

13. The rheological aid as claimed in any of claims 10 to 12, wherein R3 and R4 are hydrogen atoms.

14. The rheological aid as claimed in any of claims 10 to 13, wherein the monoamine (B) is 2,6-dimethylcyclohexylamine.

15. The rheological aid as claimed in any of claims 1 to 14, wherein the urea derivatives are preparable in the presence of at least one further compound selected from the group consisting of
(i) low molecular mass, oligomeric and polymeric compounds curable physically, thermally, with actinic radiation, and thermally and with actinic radiation (dual cure), and
(ii) surface-active substances from the group consisting of ionic and nonionic low molecular mass surfactants and ionic and nonionic oligomeric and high molecular mass surfactants.

16. The rheological aid as claimed in claim 15, wherein
the low molecular mass compounds are selected from the group consisting of reactive diluents curable thermally and with actinic radiation and crosslinking agents curable thermally, or thermally and with actinic radiation,
the oligomeric and polymeric compounds are selected from the group consisting of random, alternating and block, linear, branched and comb addition (co)polymers of olefinically unsaturated monomers, and also polyaddition resins and polycondensation resins, which are curable physically, thermally, with actinic radiation, and thermally and with actinic radiation (dual cure), and
the surfactants are selected from the group of the wetting agents.

17. The rheological aid as claimed in any of claims 1 to 16, comprising at least one silica.

18. A process for preparing a rheological aid as claimed in any of claims 1 to 17, which comprises reacting
(A) at least one compound containing at least one isocyanate group with
(B) at least one coreactant selected from the group consisting of sterically hindered primary and secondary monoamines
in an organic medium.

19. The process as claimed in claim 18, wherein the reaction of (A) with (B) is conducted in the presence of at least one further compound selected from the group consisting of
(i) low molecular mass, oligomeric and polymeric compounds curable physically, thermally, with actinic radiation, and thermally and with actinic radiation (dual cure), and
(ii) surface-active substances from the group consisting of ionic and nonionic low molecular mass surfactants and ionic and nonionic oligomeric and high molecular mass surfactants.

20. The process as claimed in claim 19, wherein
the low molecular mass compounds are selected from the group consisting of reactive diluents curable thermally and with actinic radiation and crosslinking agents curable thermally, or thermally and with actinic radiation,
the oligomeric and polymeric compounds are selected from the group consisting of random, alternating and block, linear, branched and comb addition (co)polymers of olefinically unsaturated monomers, and also polyaddition resins and polycondensation resins, which are curable physically, thermally, with actinic radiation, and thermally and with actinic radiation (dual cure), and
the surfactants are selected from the group of the wetting agents.

21. The use of the rheological aid as claimed in any of claims 1 to 17 for preparing coating materials, adhesives, and sealing compounds.

22. The use as claimed in claim 21, wherein the coating materials, adhesives, and sealing compounds are curable physically, thermally, with actinic radiation, and thermally and with actinic radiation (dual cure).

23. The use as claimed in claim 21 or 22, wherein the coating materials are used as clearcoat materials and/or as color and/or effect coating materials for the production of clearcoat systems and also single-coat or multicoat, color and/or effect, electrically conductive, magnetically shielding and/or fluorescent coatings.

24. The use as claimed in any of claims 21 to 23, wherein the coating materials, adhesives or sealing compounds are used for coating, bonding, and sealing motor vehicle bodies and parts thereof, motor vehicles inside and out, buildings inside and out, doors, windows, and furniture, and also for coating, bonding, and sealing as part of the industrial coating of small parts, coils, containers, packaging, electrical components, and white goods.
